(19) United States
(12) Patent Application Publication
(10) Pub. No.: US 2004/0183315 A1
(43) Pub. Date: Sep. 23, 2004

(54) LEVER HANDLE SAFETY STOP

(76) Inventor: Henry George O'Donohoe, Milwaukie, OR (US)

Correspondence Address: HENRY G. O'DONOHOE, 137555 SE MAPLE LANE, MILWAUKIE, OR, 97222, US

(21) Appl. No.: 10/249,209

(22) Filed: Mar. 23, 2003

(51) Int. Cl. E05C 19/18

(52) U.S. Cl. 292/288

(57) ABSTRACT

A safety device assembled on a lever handle style door opening device installed in a door to prevent the movement of the lever handle. The safety device is comprised of a covering to fit over the lever portion of a handle mounted in a door. The end of the cover farthest from the lever handle pivot has one end of a flexible connector fixedly attached. The other end of the flexible connector is fixedly attached to the door near the lever handle pivot. Whereby when the door handle lever is moved downward the flexible connector becomes taut thereby preventing the lever to continue a downward movement which would draw the door's bolt inward releasing the door latch. However, when the lever handle is moved upward the flexible connector bends allowing the upward movement to draw the door's bolt inward releasing the door latch.

### BACKGROUND OF INVENTION

This invention pertains to the use of a safety device to prevent the downward movement (or upward if reversed) of a lever type door handle.

Lever type door handles are being used extensively in homes, especially newer homes. Toddlers are notoriously curious and will try to open any door closed to them especially bathroom or closet doors. Opening such doors while unattended could present a dangerous situation for a small child.

Other safety covers and stops address the use for round door knobs not lever type door handles. For lever operating door openers the prior art uses stops to prevent the movement of the lever in any direction like a locking device.

The use of locks and keys may be used to prevent the child from opening doors but this also may produce an unsafe situation for the family. In addition, having a door, such as a bathroom door, locked to prevent entry from the outside when the room is unoccupied is an inconvenience.

### SUMMARY OF INVENTION

It is the intent of the present invention to provide a means of preventing a person especially a small child from moving the lever handle in a downward motion. Since the majority of lever handle door openers work as well when lifting on the lever the door can be opened easily by someone tall enough and knowledgeable. Toddlers and babies have difficulty reaching the lever handle on a standard house door and when they can they inherently pull down on the lever since pushing up is beyond their range of motion.

One embodiment of the present invention is a tube having a cord attached to one end, the tube slid over the door handle lever, and the free end of the cord attached to the door, thereby preventing the lever to be moved downward retracting the bolt.

Another feature of this invention is to provide a device that can easily be used on the variety of lever handle styles without modifying the door handle mechanism nor interfere with any lock operation.

Another feature of the present invention is for the door handle and door to be easily converted back to normal use when the safety feature is no longer required.

### BRIEF DESCRIPTION OF DRAWINGS

FIG. 1 is a view of the present invention showing the tube type assembly prior to mounting.

FIG. 2 is a view looking at the door face of the present invention showing the tube type assembled on the door and lever handle.

FIG. 3 is a view looking at the door face of the present invention showing the tube type assembled on the door and lever handle with the handle in the raised position.

FIG. 4 is a view looking at the door edge of the present invention showing the tube type assembled on the door and lever handle and of the flexible connector connection to the door.

### DETAILED DESCRIPTION

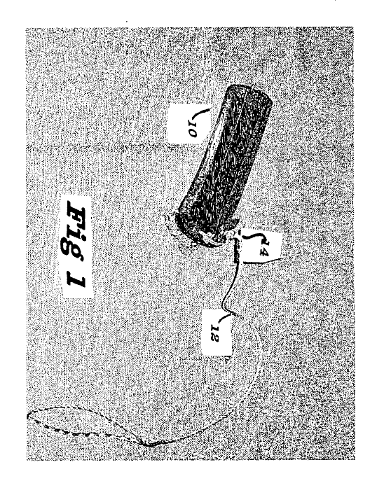

FIG. 1 shows a preferred embodiment using a tube 10, with a cord 12 attached to one end of tube 10 by attaching means 14. Tube 10 can be metal, plastic, rubber, or the like. A clear plastic tube is used in the figures to more clearly illustrate the positioning of the tube on the handle. The material used for tube 10 however, must be such that it will not over stretch when attempting to move a lever handle. If the material to be used for tube 10 is liable to mar the surface finish of the handle a softer liner material should be used. Cord 12 needs to be flexible so the handle can move upward and, therefore, can also be a cord, string, twine, thread, cable, rope, wire, length of thin plastic, fishing line leader, chain, or the like. Attaching means 14 as shown consists of a hole punched in the wall of tube 10 near one end and a loop formed by passing a plastic “zip-tie” through the hole and secured. Cord 12 is threaded through the loop and folded back to meet cord 12 and a knot tied. Other methods of attaching include inserting a grommet, passing the cord 12 through the grommet and tying a knot in cord 12; instead of tying a knot, a crimped on fitting can be used to secure the cord 12; a clip can be placed on the end of tube 10 and cord 12 attached to the clip; a screw or screw eye can be screwed into the wall of tube 10 and cord 12 attached to the screw or screw eye; and other similar means and more complex means may also be used.

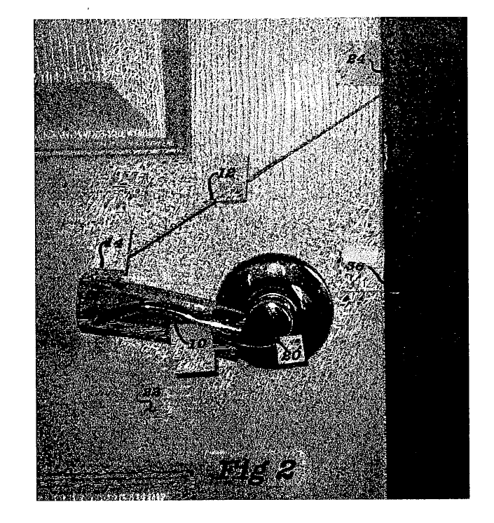

FIG. 2 shows the tube 10 mounted on the lever handle 20 that is assembled into the door 22. The cord 12 is attached to tube attaching means 14 and to the door 22 by attaching means 24. It is best if the tube is approximately the same length as the handle. The tube is slid over the lever handle 20 with the location of attaching means 14 to be farthest from the lever handle 20 pivot. Cord 12 is attached to the edge of door 22 by door attaching means 24 and cord 12 should be almost taut. The door attaching means 24 must be higher than the door bolt 36 to prevent downward movement of the lever handle 20. The attaching means 24 is in the door edge but can be on the face of the door. Using the door edge eliminates the possibility of marring the surface of the door. The cord 12 is shown attached approximately 6 inches above the door bolt 36, but the height above the door bolt 36 is not critical. When so assembled as shown the downward movement of lever handle 20 is prevented which in turn prevents door bolt 36 from retracting.

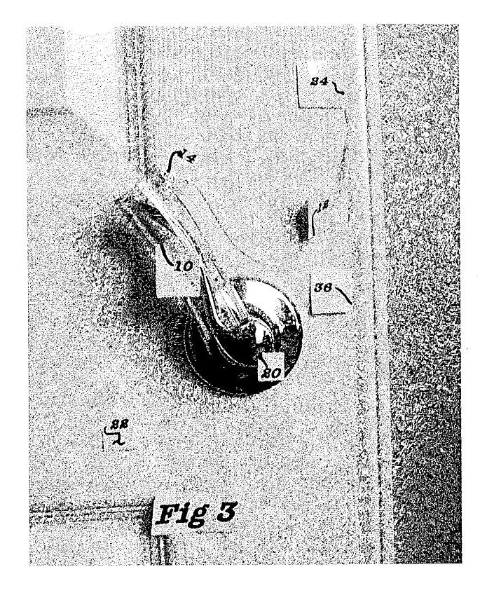

FIG. 3 shows the assembly as shown in FIG. 2 but with the lever handle 20 in the raised position. The cord 12 is now in a relaxed position and the door bolt 36 is retracted allowing the door to be opened.

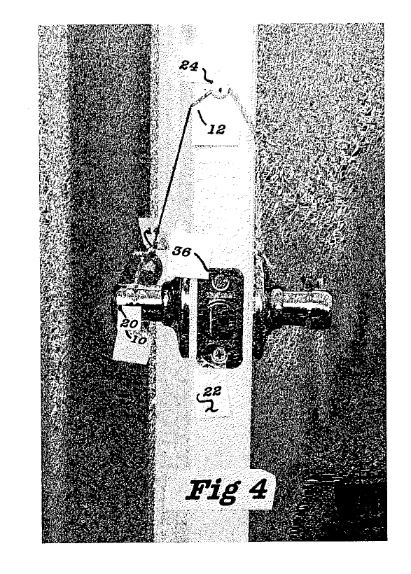

FIG. 4 shows an attaching method of cord 12 to door 22. A thumbtack 24 is inserted into door 22 edge and cord 12 wrapped around the tack 24. The attaching of cord 12 to the door 22 can also be accomplished using staples, a nail, a screw or the like. The attachment of cord 12 to door 22 must be such that cord 12 will not be released when drawn taut when the lever handle 20 is pushed down. The attachment means 24 must not stick out from the edge of the door so far that closing of the door cannot be accomplished.

Another embodiment is a cap placed over the end of the lever handle having a cord 12 attached to the cap. A cap is a tube with one end closed. Attachment means to the cap would be substantially the same as that for the tube. The cap can be metal, plastic, rubber, or the like and must be such that it will not over stretch when attempting to move lever handle 20.

A further embodiment is the use of a material wrapped around the lever handle in place of the tube 10. In addition to a wrapped material the wrap must be secured so as not to fall off the handle and be sufficient to withstand the forces applied to the lever handle 20 and resisted by cord 12.

I claim:

1. A device assembled on a lever handle style door opening device installed in a door to prevent the movement of the lever handle comprising:
A covering to fit over the lever portion of a handle mounted in a door with a first end located farthest from the lever handle pivot;
a flexible connector having a first end fixedly attached to said covering first end and a second end fixedly attached to the door near the lever handle pivot;
said flexible connector to be of sufficient length to reach from said covering first end to a point above the lever handle on said door; and
a means of fixably attaching said flexible connector second end to said door, said means when installed does not interfere with the closing of said door;
whereby when the door handle lever is moved downward the flexible connector becomes taut thereby preventing the lever to continue a downward movement which would draw the door bolt inward releasing the door latch, however, when the lever handle is moved upward the flexible connector bends allowing the upward movement to draw the door bolt inward releasing the door latch.

2. The device according to claim 1 wherein said covering has an internal lining of soft material to prevent scratching of the lever surface.

3. The device according to claim 1 wherein said covering is a tube having a sufficient inside diameter to slidibly fit over said lever with a first end located farthest from the lever handle pivot and a second end resting against the lever handle pivot;
said tube being of sufficient length to cover a minimum of half the length of said lever.

4. The device according to claim 1 wherein said covering is a cap having a sufficient inside opening to fit over the free end of said lever.

5. The device according to claim 1 wherein said covering is wrapped around said lever with a first end located farthest from the lever handle pivot and a second end resting against the lever handle pivot;
and means to secure the covering wrapped around said lever to maintain the covering in position.

6. The device according to claim 1 wherein said flexible connector comprises:
a first non-flexible member having a first end and a second end, the first end corresponding to said flexible connector first end;
a second non-flexible member having a first end and a second end, the second end corresponding to said flexible connector second end; and
the first non-flexible member second end is pivotably connected to the second non-flexible member first end.

7. The device according to claim 1 wherein said flexible connector comprises:
a first non-flexible member having a first end and a second end, the first end corresponding to said flexible connector first end;
a second non-flexible member having a first end and a second end, the second end corresponding to said flexible connector second end;
at least one pivotably interconnected non-flexible member having a first end pivotably connected to said first non-flexible member second end and a second end pivotably connected to said second non-flexible member first end.

8. The device according to claim 1 wherein said flexible connector to be of sufficient length to reach from said covering first end to a point below the lever handle on said door;
whereby when the door handle lever is moved upward the flexible connector becomes taut thereby preventing the lever to continue an upward movement and releasing the door latch, however when the lever handle is moved downward the flexible connector bends allowing the downward movement to continue releasing the door latch.
